(19) United States
(12) Patent Application Publication
(10) Pub. No.: US 2008/0201155 A1
(43) Pub. Date: Aug. 21, 2008

(54) Valet package handling

(76) Inventor: Kamales Som, Santa Ana, CA (US)

Correspondence Address: PATENT LAW & VENTURE GROUP, 2424 S.E. BRISTOL, SUITE 300, NEWPORT BEACH, CA, 92660, US

(21) Appl. No.: 11/708,188

(22) Filed: Feb. 20, 2007

(51) Int. Cl. G06Q 30/00

(52) U.S. Cl. 705/1

(57) ABSTRACT

A method of reducing the burden, of carrying packages during a shopping trip to a mall type shopping center with retail stores, includes interconnecting valet kiosks with a computer network. Shoppers can conveniently drop packages at the nearest kiosk and be free to continue shopping. Shoppers receive a wallet sized card with claim information encoded magnetically or otherwise. The card is swiped at each kiosk where another package is dropped off. All information is routed to a central computer server. Shoppers need only let an attendant at a kiosk know that they are leaving for the day to have their packages moved to their valet-parked vehicle. If the vehicle is self-parked, the packages are moved to a drive-up locker which is opened by swiping the card.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to methods in retail shopping and more particularly to methods of handling goods purchased at retail between a point of purchase and a point of delivery of the goods to the shopper.

2. Description of Related Art Including Information Disclosed Under 37 CFR 1.97 and 1.98

Rivalto, 20060020489 discloses a system and method for automated package delivery and pick-up including at least one package portal located in a delivery and pick-up station to receive and. dispense packages from the station. A station controller is coupled to an information input system and the package receiving and dispensing portal mechanism, and is arranged to associate package and intended recipient identification information with a received package. The controller is also arranged to process identification information, which may include biometric information, to authenticate the identity of an intended recipient, and to permit dispensing of the package from the at least one portal in response thereto. The station supports unattended delivery and pick-up of packages to improve overall efficiency of a package delivery system as well as user convenience and safety.

Ross, 20020016726 discloses a method and system for delivering packages to a depot delivery destination selected by a customer for package pickup. Participating home shopping merchants allow customers to purchase goods at home and to ship their purchases to a nearby depot delivery destination to be picked up when, convenient. The packages from the home-shopping merchants are stored in a secure unit at the depot's customer service center until customer pickup. The delivery system is designed to provide consumers with package security from order to final delivery. The delivery system present invention may also provide the customers with the ability to track their orders at any time without the intervention of merchant customer service personnel.

Som, U.S. Pat. No. 7,124,940 discloses a shopping method comprising the steps of displaying a line of merchandise within a retail establishment; training sales assistants to operate portable sales checkout devices and to match the line of merchandise with shoppers' needs; recording purchases and simultaneously producing and delivering a paper sales receipt and a paper pickup voucher to each of the shoppers wherein, the pickup voucher identifies a pickup point access code, pickup point identity and pickup point compartment identity; reserving the pickup point compartment associated with the compartment identity; wrapping and marking the purchases with a pickup point access code, pickup point identity and pickup point compartment identity; delivering the purchases to the pickup compartments and enabling the pickup vouchers of the shoppers to provide access to the respective pickup compartments.

Baughman, III , et al., U.S. Pat. No. 6,964,321 discloses a method and system for presenting merchandise on a paved surface which employs permanently installed anchors each having a vertical sleeve. Poles of common height are inserted within the sleeves of the anchors in a manner defining a three dimensional merchandising region. The tops of the poles are interconnected by tensioned cable assemblies from which informational signage is suspended and retained by lower disposed retainer tensioned cables. Merchandising bays are established between mutually adjacent poles and entrance and exit regions are established in conjunction with a shopper aisle. A canopy is supported by poles and anchors over a cash/wrap station at the exit region.

Hungerford, III, U.S. Pat. No. 6,68,4980 discloses a package and delivery system method and display to be used in a retail business environment where customers choose to purchase an item represented by a displayed example. The delivery is handled through a central facility and a post card is used by the purchaser to notify the recipient of the impending receipt of the purchased item. The invention allows for a retailer to operate in essentially an inventory free environment. Graphic designs included on the postcard may be limited edition prints.

Stevens, U.S. Pat. No. 6,480,758 discloses a package storage and delivery system including electronically controlled lockers disposed at or near customer locations. Each locker is unlocked by a courier, preferably by means of a short-range transceiver or transmitter carried on the courier's person. The customer can unlock the locker and receive the delivered package. Cryptographically signed communications are employed along with nonvolatile usage logs to minimize the risk of loss of a package or fraud by courier or customer. The lockers may be stackable, permitting a delivery courier to add lockers in the event a customer receives too many deliveries to fit into a single locker. Each box has, of course, a physical location, and has associated with it an address code indicative of the physical location, for example by means of a human-readable or compressed representation of the precise latitude and longitude. A package delivered to such a box preferably bears the address code. A merchant can greatly reduce the risk of credit card fraud by requiring the use of such codes for the simple reason that a fraudulent transaction may be traced to a specific physical location.

Ogilvie, et al., U.S. Pat. No. 6,344,796 discloses an unattended package delivery cross-docking apparatus including a plurality of storage devices, each having a door with a lock that is locked and unlocked in response to codes. A local lock controller is associated with each of the storage devices and includes an entry device for entering an access code that unlocks the lock when it is locked and a transaction code that locks the lock when it is unlocked. A central operations controller in communication with the local lock controllers is programmed to receive the access and transaction codes entered to each local lock controller, to create an access code for the lock of each storage device upon receiving a transaction code that locks the lock, and to output a notice of the access code to be used to unlock the lock of each storage device when it is locked.

The related art described above discloses package handling systems. However, the prior art fails to disclose the present method of handling shopping packages in a shopping, strip mall environment, cohesive shopping district wherein packages are gathered and moved to a pickup point or the shopper's vehicle by other then the shopper. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

A method of reducing the burden, of carrying packages during a shopping trip in a mall type shopping center with retail stores, includes interconnecting valet kiosks with a computer network. Shoppers can conveniently drop packages at the nearest kiosk and be free to continue shopping. Shoppers receive a wallet sized card with claim information encoded magnetically or otherwise. The card is swiped at each kiosk where another package is dropped off. All information is routed to a central computer server. Shoppers need only let an attendant at a kiosk know where they wish to pick up their packages and possibly that they are leaving the mall to have their packages moved to their preselected pickup point or valet-parked vehicle. If the vehicle is self-parked, the packages are moved to a drive-up locker which is opened by swiping the card.

A primary objective inherent in the above described apparatus and method of use is to provide advantages not taught by the prior art.

Another objective is to significantly reduce the burden of carrying packages during a shopping trip to a mall or shopping center.

A further objective is eliminate the necessity of carrying packages from the shopping areas to a vehicle.

A still further objective is to enable the use of entertainment and dinning facilities within a shopping plaza, mall or center without being encumbered by packages.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of an interchange between a shopper and a valet package service within a shopping center; and

FIG. 2 is a schematic diagram showing, in plan view, a typical shopping center wherein the method of the invention is able to be carried out.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

Described now in detail is an improved shopping method. Typically, a shopping center has a plurality of retail sales locations or stores, and today, some of these shopping centers have hundreds of stores which are located side-by-side over considerable distances on pedestrian thoroughfares or walkways. Shoppers are able to move over these thoroughfares and into the retail establishments to make purchases and receive packages of their goods at these points of purchase. Because one may wish to shop at stores that happen to be far apart, it is a nuisance, and often quite difficult for some individuals, to carry their packages while they continue to shop. Furthermore, if the burden of carrying packages is great enough, one may be forced to cut short the intended shopping trip. If the shopping trip includes stopping at a restaurant, a theatre or other entertainment found in today's shopping malls, the shopping experience can be improved considerably by being relieved of ones packages. This ability to relieve shoppers of their packages is most beneficial to those using walking aids such as crutches, canes and walkers; those with leg or arm weakness, those in wheelchairs and, most generally, older persons. Clearly, too, there is an advantage to mall managers and store owners to extend the length of shopping trips. If, for instance, every shopper were to extend their shopping trip by, say, twenty-five percent, this alone is equivalent to increasing foot traffic in the mall by that same factor, with the bonus of not requiring any increase in parking facilities whatsoever.

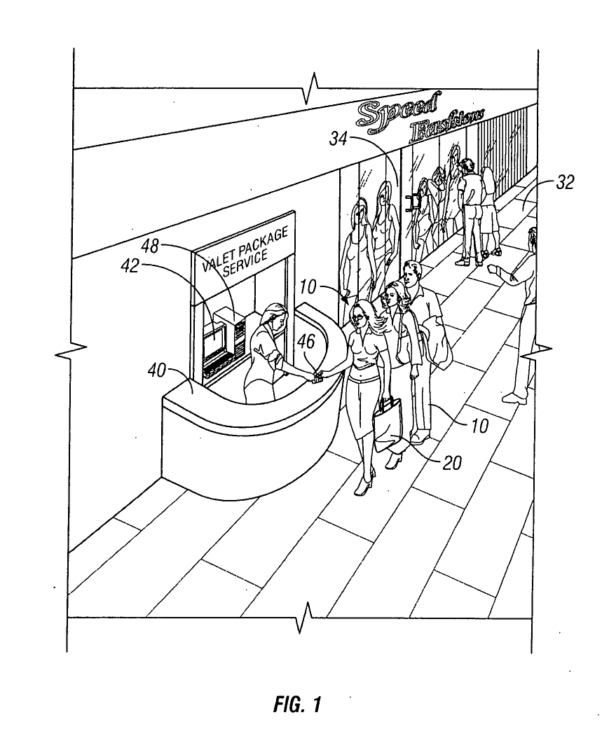

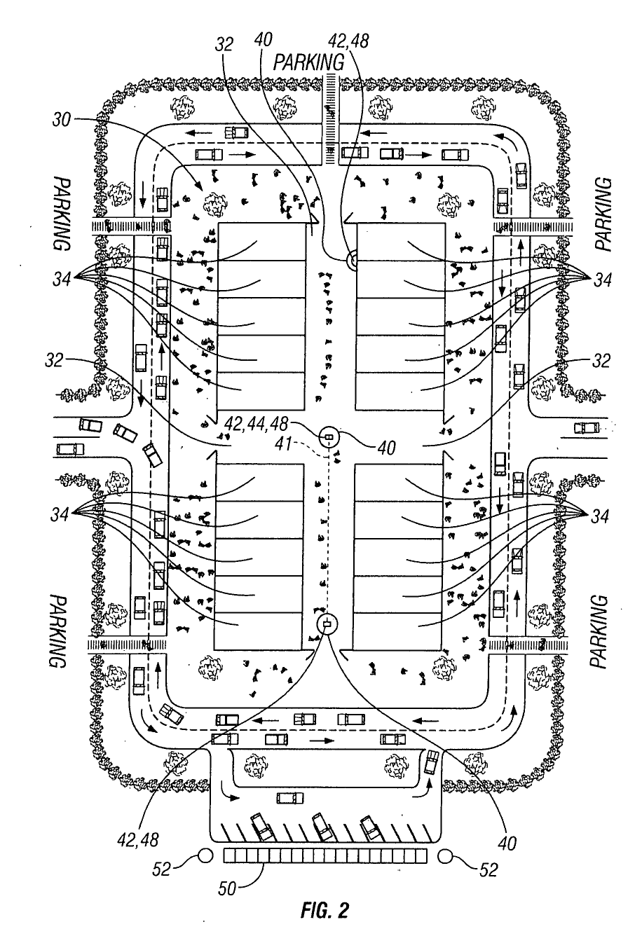

The present invention is a method of reducing the burden to shoppers 10 of having to carry their packages 20 during a shopping trip at a shopping center or shopping mall 30. In this description the terms “shopping mall” and “mall” are used to represent any type of shopping facility, especially those that handle high foot traffic, offer entertainment and restaurants, and those that are physically expansive or are frequented by large numbers of older persons. The method describes a valet package handling service. The method comprises establishing a plurality of package valet centers 40 spaced apart along the pedestrian thoroughfares 32 of the mall 30 adjacent to its retail stores 34 (FIG. 1). These valet centers 40 may advantageously be kiosks or other small or free-standing structures, such as counters (FIG. 2), preferably positioned and spaced apart on the thoroughfares 32. Conceptually, one might place such valet centers 40 at no more than 500 foot increments throughout the mall 30. Therefore, on average, shoppers need only walk approximately 250 feet or less from a store 34 to one of the valet centers 40 where they can drop their packages 20. Alternately, retailers might advantageously provide room for such valet centers 40 within the retail stores 34.

Preferably, each of the valet centers 40 operates with a microcomputer 42 which is integrated with all of the other valet centers 40 through a network 41 with a computer server 44. Shoppers 10 typically make purchases in one or several retail stores.34 within the mall 30. The shopper's packages 20 are given (dropped) at one or more of the valet centers 40 over the course of the shopping trip. At the first package drop, a card preparation device 48 is used to imprint a credit card size wallet card 46. This card 46 has laid-down on it, a magnetic stripe containing the name of the shopper 10, and claim information including a claim number, the number of packages checked by the shopper 10 and the pickup point if the shopper knows. In this disclosure and claims the term “card 46” is used to represent both the above described card with magnetic stripe, as well as any other equivalent device. For instance, a paper receipt may suffice where the paper receipt includes a printed bar code which may be read by a bar code reader instead of a magnetically embedded information stripe reader. The shopper may elect to disclose the pickup point sometime later or just before leaving the mall. Also, the shopper may elect to change the pickup point at any time during the shopping trip. This claim information is also attached to the package or packages 20. The preparation device 48 is able to read the wallet cards 46 so that if the shopper 10 loses their card 46 during the shopping trip, those who find it are not able to use it since they will not have corresponding personal identification. Also, by presenting identification, a shopper is able to easily obtain a replacement of the card.

Each time a shopper drops a package at one of the valet centers 40, the shopper's wallet card 46 is scanned and the number of packages identified is incremented in both the card 46 as well as in the server 44. The card scanning device is typically an integral part of the card preparation device 48, and these devices are well known in the art. When the shopper wishes to leave the mall 30, the shopper informs any one of the valet centers 40, in person, or by cell phone, and the packages at each of the valet centers 40 are gathered and taken to, by valet personnel, and placed into the shopper's valet parked vehicle, or to a drive-up package locker 50 located convenient to the self-parking area of the mall 30. Alternately, when the shopper wishes to leave the mall 30, the shopper may pick up the at least one package from a pre-selected one of the package valet centers. Lockers 50 may be managed by a locker staff, or preferably, the shopper 10 will swipe the wallet card 46 on a card reader 52 adjacent to the lockers 50, whereupon, the shopper's locker 50 is automatically unlocked and opened. Alternatively, when the shopper 10 swipes the wallet card 46 at the card reader 52, the reader's screen shows the locker number and location and may unlock the locker door. In the case where the locker door is not unlocked by the card reader 52, a second reader attached to the locker itself functions to unlock the locker door.

In a further embodiment, a valet parking operation, servicing the mall 30 may function as a part of the above described valet package handling service. In this instance, upon completion of shopping, the shopper's packages 20 are placed within the shopper's vehicle and the vehicle is then delivered to a vehicle pickup location, adjacent to the mall 30 for convenient turnover to the shopper 10.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. In a shopping center having a plurality of retail sales locations spaced apart along a pedestrian thoroughfare, a method of reducing the burden, to shoppers, of carrying packages during a shopping trip, the method comprising the steps of:
A) establishing a plurality of package valet centers, the valet centers spaced apart along the pedestrian thoroughfare;
B) integrating a network of microcomputers with the valet centers, the microcomputers in communication with a computer server;
C) for each shopper:
a) receiving at least one package of purchased goods from at least one of the retail sales locations;
b) dropping the at least one package at one of the valet centers;
c) entering personal identification and claim information into a wallet card using a card maker at the one of the valet centers, the claim information including a quantity of valet packages and a preferred pickup point;
d) entering the claim information into the computer server through one of the microcomputers at the one of the valet centers by swiping the wallet card through a card reader;
e) issuing the wallet card to the shopper;
f) securing the at least one package at the preferred pickup point when the shopping trip is completed.

2. The method of claim 1 wherein the pickup point is a package locker convenient to a self parked vehicle of the shopper and entrance to the package locker is gained using the wallet card.

3. The method of claim 1 wherein the pickup point is a pre-selected one of the package valet centers and access to the at least one package is gained using the wallet card.

4. The method of claim 1 further comprising the steps of receiving a further package of purchased goods from another of the retail sales locations, dropping the further package at one of the valet centers, and swiping the wallet card to increment a quantity of valet packages stored in the claim information of the wallet card.

5. In a shopping center having a plurality of retail sales locations spaced apart along a pedestrian thoroughfare, a method of reducing the burden, to shoppers, of carrying packages during a shopping trip, the method comprising the steps of:
A) establishing a plurality of package valet centers, the valet centers spaced apart along the pedestrian thoroughfare;
B) integrating a network of microcomputers with the valet centers, the microcomputers in communication with a computer server;
C) for each shopper:
a) valet parking a vehicle at the shopping center;
b) receiving at least one package of purchased goods from at least one of the retail sales locations;
c) dropping the at least one package at one of the valet centers;
d) entering personal identification and claim information into a wallet card using a card maker at the one of the valet centers, the claim information including a quantity of valet packages;
e) entering the claim information into the computer server through one of the microcomputers at the one of the valet centers by swiping the wallet card through a card reader;
f) issuing the wallet card to the shopper; and
g) securing the at least one package in the shopper's valet-parked vehicle.

6. The method of claim 5 further comprising the steps of receiving a further package of purchased goods from another of the retail sales locations, dropping the further package at one of the valet canters, and swiping the wallet card to increment a quantity of valet packages stored in the claim information of the wallet card.

7. The method of claim 5 further comprising the step of delivering the valet-parked vehicle to a shopper vehicle pickup point.
